(19) United States
(12) Patent Application Publication
(10) Pub. No.: US 2022/0361119 A1
(43) Pub. Date: Nov. 10, 2022

(54) TECHNIQUES FOR REQUESTING MESSAGE REPETITION IN RANDOM ACCESS PROCEDURES

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Gokul SRIDHARAN, Sunnyvale, CA (US); Hung Dinh LY, San Diego, CA (US); Xiao Feng WANG, San Diego, CA (US); Yan ZHOU, San Diego, CA (US)

(21) Appl. No.: 17/738,887

(22) Filed: May 6, 2022

Related U.S. Application Data
(60) Provisional application No. 63/186,617, filed on May 10, 2021.

(51) Int. Cl. H04W 52/36; H04W 52/24; H04W 74/08

(52) U.S. Cl. CPC H04W 52/367; H04W 52/242; H04W 74/0833

(57) ABSTRACT

This disclosure provides systems, methods and apparatus, including computer programs encoded on computer storage media, for requesting message repetition in random access procedures. In some aspects, a first random access message can be generated for a physical random access channel (PRACH) procedure. The first random access message can include a request for repetition of a third random access message. The request can be based on a criterion that is associated with at least one of a maximum allowed transmit power, or a PRACH transmit power. The first random access message can be output for transmission to a node to initiate a random access procedure with the node. In some aspects, one or more parameters related to a threshold for determining whether to include the request can be configured by the node.

### CLAIM OF PRIORITY UNDER 35 U.S.C. § 119

The present Application for Patent claims priority to Provisional Patent Application No. 63/186,617, entitled “TECHNIQUES FOR REQUESTING MESSAGE REPETITION IN RANDOM ACCESS PROCEDURES” filed May 10, 2021, which is assigned to the assignee hereof and hereby expressly incorporated by reference herein for all purposes.

### TECHNICAL FIELD

This disclosure relates to wireless communication systems, and to performing random access procedures.

### DESCRIPTION OF THE RELATED TECHNOLOGY

Wireless communication systems are widely deployed to provide various types of communication content such as voice, video, packet data, messaging, broadcast, and so on. These systems may be multiple-access systems capable of supporting communication with multiple users by sharing the available system resources (such as time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In some aspects, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

In some wireless communication technologies, such as 5G NR, user equipment (UEs) can perform a random access procedure with a base station to establish a connection and receive resources for communicating therewith.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a user equipment (UE). The method can include generating a first random access message for a physical random access channel (PRACH) procedure, wherein the first random access message includes a request for repetition of a third random access message, wherein the request is based on a criterion that is associated with at least one of a maximum allowed transmit power, or a PRACH transmit power, and outputting the first random access message for transmission to a node to initiate a random access procedure with the node.

Another innovative aspect of the subject matter described in this disclosure can be implemented in a method for wireless communications at a network node, including transmitting, to a UE, a configuration indicating one or more parameters for selecting, based on a criterion that is associated with at least one of a maximum allowed transmit power of the UE, or a PRACH transmit power of the UE, whether to request repetition of a third random access message in a PRACH procedure, and receiving, from the UE, a first random access message including a request for repetition of the third random access message.

Another innovative aspect of the subject matter described in this disclosure can be implemented in an apparatus that can include a memory configured to store instructions, and one or more processors configured to execute the instructions and cause the apparatus to perform one or more of the methods described above and further herein.

Another innovative aspect of the subject matter described in this disclosure can be implemented in an apparatus that can include means for performing one or more of the methods described above and further herein.

Another innovative aspect of the subject matter described in this disclosure can be implemented in a computer-readable medium that can include code executable by one or more processors to perform one or more of the methods described above and further herein.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2 is a diagram illustrating an example of disaggregated base station architecture.

FIG. 3 illustrates an example of a user equipment (UE).

FIG. 4 illustrates an example of a base station.

FIG. 5 illustrates an example of a flow chart for requesting resources for repetition of an uplink channel transmission in a random access procedure.

FIG. 6 illustrates an example of a flow chart for configuring a device for requesting resources for repetition of an uplink channel transmission in a random access procedure.

FIG. 7 illustrates an example of a communications flow between a UE and a node for requesting resources for Msg3 retransmission.

FIG. 8 illustrates a block diagram of an example of a communication system including a base station and a UE.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or interne of things (IOT) network, such as a system utilizing 3G, 4G or 5G, or further implementations thereof, technology.

In some wireless communication technologies, such as 5G, user equipment (UEs) are able to perform random access procedures (also referred to as physical random access channel (PRACH) procedures) with a node, such as a base station or a disaggregated component of a base station deployed in an Open Radio Access Network (O-RAN), over corresponding PRACH resources to establish communications with the node. Some random access procedures in 5G NR have a four message format. In such procedures, the UE can transmit, to the node, a first message (Msg1) that includes a random access preamble (also referred to as a PRACH preamble). The UE can receive, from the node, a second message (Msg2) that includes a random access response (RAR) that can schedule resources for an uplink channel transmission (such as physical uplink shared channel (PUSCH) transmission) or one or more repetitions thereof. The UE can transmit, to the node, a third message (Msg3) that includes an uplink channel transmission or one or more repetitions thereof. The UE can receive, from the node, a fourth message (Msg4) that can include contention resolution information.

In an example, the UE can request resources for repetition of the uplink channel transmission transmitted in Msg3 associated with one or more criteria, such as a synchronization signal (SS)-reference signal received power (RSRP) measured for a SS received from the node. In such an example, where the SS-RSRP does not meet a threshold RSRP, the UE can request, such as in Msg1, resources for repetition of the uplink channel transmission in Msg3. In some examples, however, uplink RSRP may be an indicator of coverage of Msg3, and may be used to determine whether to request resources for repetition of the uplink channel transmission. In addition, for example, in 5G NR, UEs can be of different power classes that are associated with different maximum transmit power levels. For example, in 5G NR, a UE can have one of four possible power classes, where each power class is associated with a maximum allowed transit power, such as a maximum defined Effective Isotropic Radiated Power EIRP or Total Radiated Power (TRP), which may vary per operating band.

Aspects described herein relate to requesting, in Msg1 of a random access procedure, resources for repetition of an uplink channel transmission in Msg3 of the random access procedure. Requesting resources for repetition can be based on a criterion that is associated with a UE power class, maximum allowed transmit power at the UE, or a PRACH transmit power (such as the transmit power used to transmit Msg1 or other random access procedure messages) at the UE. In an example, the maximum allowed transmit power at the UE can be impacted by a maximum permissible exposure (MPE) event. For example, a MPE event can occur when a user is in close proximity to radiating elements of the UE, and the UE can be notified of the event and can reduce maximum transmit power. In this example, requesting resources for uplink channel transmission repetition for Msg3 associated with the maximum allowed transmit power can allow for requesting resources for repetition in the case of MPE event when transmit power is degraded.

In some examples, a UE can request resources for repeating an uplink channel transmission, where the request can be associated with comparing the SS-RSRP (or other SS block (SSB) measurement) to the threshold RSRP. In such examples, the UE can modify the threshold or comparison associated with the UE power class, maximum allowed transmit power, or PRACH transmit power. In some examples, the node may configure the UE with the threshold adjustment associated with UE power class, or may configure the UE with various parameters for determining the threshold or a correction for the threshold. In some other examples, the UE can request resources for repeating an uplink channel transmission, where the request can be associated with a measured uplink (UL) RSRP, which may be associated with a maximum allowed transmit power and a path loss between the UE and the node. In addition, for example, whether to use SS-RSRP or UL-RSRP may be associated with whether a paired or un-paired spectrum is used or may be configured by the node.

Particular implementations of the subject matter described in this disclosure can be implemented to realize one or more of the following potential advantages. Using UE power class or other transmit power parameters to determine when to request resources for repetition of the uplink channel transmission for Msg3 may improve the likelihood that Msg3 is received in cases where the UE transmit power is lower (such as during an MPE event), rather than just being associated with RSRP of signals received from the node, which may not take UE transmit power into account. Improving Msg3 transmission in this regard may improve likelihood of success of the random access procedure, which may improve connection rate for the UE and user experience for users using the UE. Improving Msg3 transmission in this regard may also improve efficiency of resource usage for Msg3 repetition by having a more accurate determination of when to use the resources, thus preventing unnecessary usage of repetition resources as well.

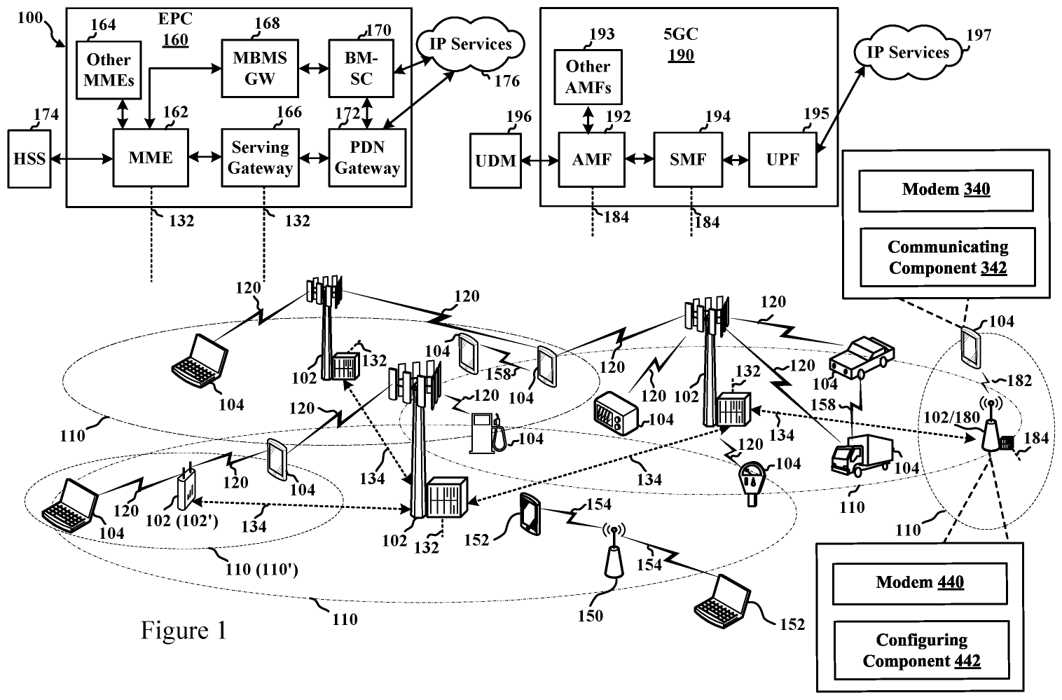

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, or a 5G Core (5GC) 190. The base stations 102 may include macro cells (high power cellular base station) or small cells (low power cellular base station). The macro cells can include base stations. The small cells can include femtocells, picocells, and microcells. In an example, the base stations 102 also may include gNBs 180, as described further herein. In one example, some nodes of the wireless communication system may have a modem 340 and communicating component 342 for requesting resources for repetition of an uplink channel transmission in a random access procedure, in accordance with aspects described herein. In addition, some nodes may have a modem 440 and configuring component 442 for configuring a device for requesting resources for repetition of an uplink channel transmission in a random access procedure, in accordance with aspects described herein. Though a UE 104 is shown as having the modem 340 and communicating component 342 and a base station 102/gNB 180 is shown as having the modem 440 and configuring component 442, this is one illustrative example, and substantially any node or type of node may include a modem 340 and communicating component 342 or a modem 440 and configuring component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (such as using an 51 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or 5GC 190) with each other over backhaul links 134 (such as using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network also may include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (such as for x component carriers) used for transmission in the DL or the UL direction. The carriers may or may not be adjacent to each other. Allocation of carriers may be asymmetric with respect to DL and UL (such as more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in a traditional sub 6 GHz spectrum, in millimeter wave (mmW) frequencies, or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The gNB 180 (such as a mmW base station) may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (such as from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, or other IP services.

The base station also may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 or gNB 180 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, communicating component 342 can request resources for repetition of an uplink channel transmission in a random access procedure, where the request can be based on a criterion that can be associated with a maximum allowed transmit power at the UE 104 or a PRACH transmit power at the UE 104. The maximum allowed transmit power may be set for a power class of the UE 104, based on occurrence of an MPE event, etc. In an example, configuring component 442 may configure the UE 104 with parameters for comparing a signal power measurement to a threshold as part of requesting, or determining whether to request, the resources for repetition of the uplink channel transmission or not. In the examples described herein, requesting, or determining whether to request, resources for repetition of the uplink channel transmission based on a transmit power of the UE 104 may improve the determination of whether to request resources for repetition as being based on the transmit power that is likely used in transmitting the uplink channel transmission.

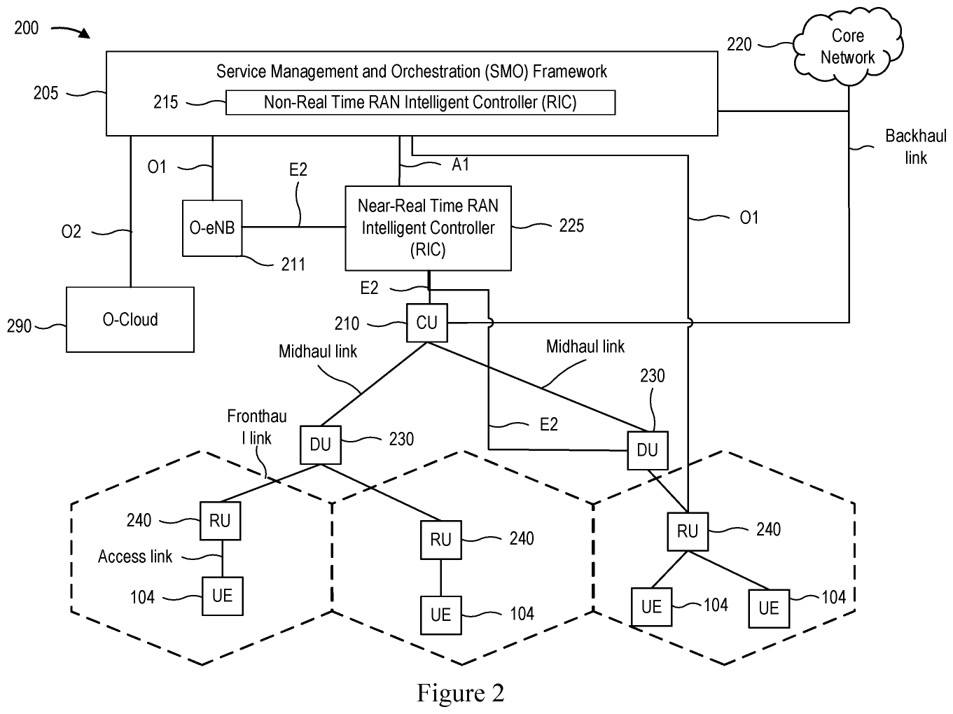

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

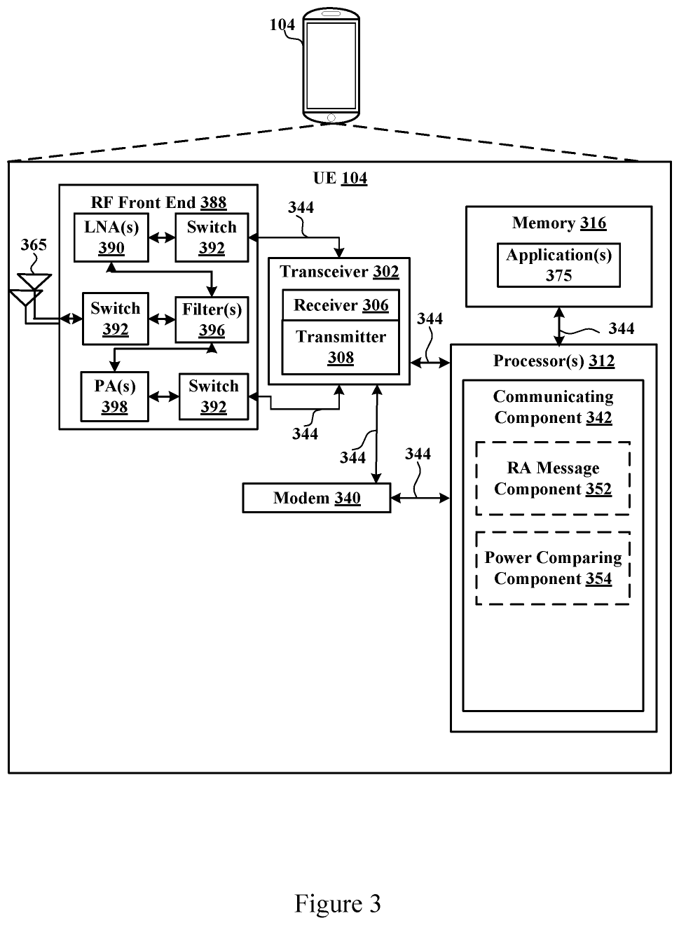

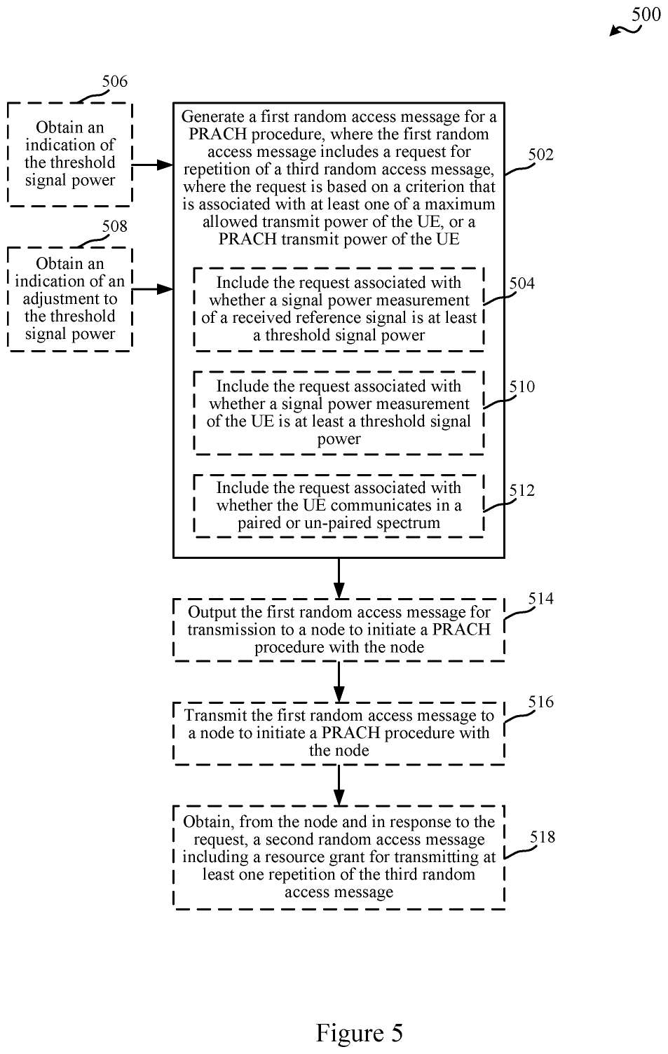

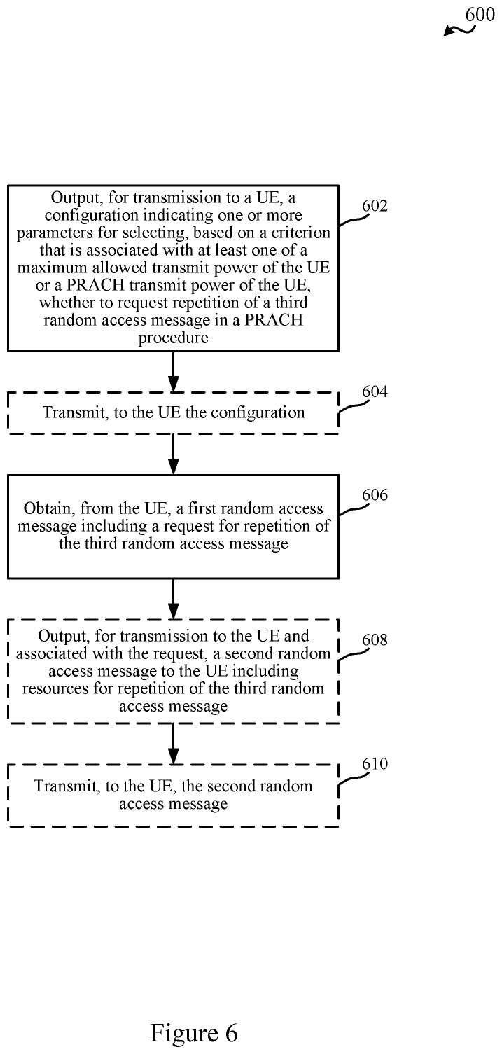

Turning now to FIGS. 3-7, aspects are depicted with reference to one or more components and one or more methods that may perform the actions or operations described herein, where aspects in dashed line may be optional. Although the operations described below in FIGS. 5 and 6 are presented in a particular order or as being performed by an example component, it should be understood that the ordering of the actions and the components performing the actions may be varied, depending on the implementation. Moreover, it should be understood that the following actions, functions, or described components may be performed by a specially programmed processor, a processor executing specially programmed software or computer-readable media, or by any other combination of a hardware component or a software component capable of performing the described actions or functions.

FIG. 3 illustrates an example of a user equipment (UE) 104. The UE 104 may include a variety of components, some of which have already been described above and are described further herein, including components such as one or more processors 312 and memory 316 and transceiver 302 in communication via one or more buses 344, which may operate in conjunction with modem 340 or communicating component 342 for requesting resources for repetition of an uplink channel transmission in a random access procedure, as described herein.

In some aspects, the one or more processors 312 can include a modem 340 or can be part of the modem 340 that uses one or more modem processors. Thus, the various functions related to communicating component 342 may be included in modem 340 or processors 312 and, in some aspects, can be executed by a single processor, while in other aspects, different ones of the functions may be executed by a combination of two or more different processors. For example, in some aspects, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 or modem 340 associated with communicating component 342 may be performed by transceiver 302.

Also, memory 316 may be configured to store data used herein or local versions of applications 375 or communicating component 342 or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In some aspects, for example, memory 316 may be a non-transitory computer-readable storage medium that stores one or more computer-executable codes defining communicating component 342 or one or more of its subcomponents, or data associated therewith, when UE 104 is operating at least one processor 312 to execute communicating component 342 or one or more of its subcomponents.

Transceiver 302 may include at least one receiver 306 and at least one transmitter 308. Receiver 306 may include hardware or software executable by a processor for receiving data, the code including instructions and being stored in a memory (such as computer-readable medium). Receiver 306 may be, for example, a radio frequency (RF) receiver. In some aspects, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware or software executable by a processor for transmitting data, the code including instructions and being stored in a memory (such as computer-readable medium). A suitable example of transmitter 308 may including, but is not limited to, an RF transmitter.

Moreover, in some aspects, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In some aspects, LNA 390 can amplify a received signal at a desired output level. In some aspects, each LNA 390 may have a specified minimum and maximum gain values. In some aspects, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In some aspects, each PA 398 may have specified minimum and maximum gain values. In some aspects, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in some aspects, for example, a respective filter 396 can be used to filter an output from a respective PA 398 to produce an output signal for transmission. In some aspects, each filter 396 can be connected to a specific LNA 390 or PA 398. In some aspects, RF front end 388 can use one or more switches 392 to select a transmit or receive path using a specified filter 396, LNA 390, or PA 398, based on a configuration as specified by transceiver 302 or processor 312.

As such, transceiver 302 may be configured to transmit and receive wireless signals through one or more antennas 365 via RF front end 388. In some aspects, transceiver may be tuned to operate at specified frequencies such that UE 104 can communicate with, for example, one or more base stations 102 or one or more cells associated with one or more base stations 102. In some aspects, for example, modem 340 can configure transceiver 302 to operate at a specified frequency and power level based on the UE configuration of the UE 104 and the communication protocol used by modem 340.

In some aspects, modem 340 can be a multiband-multimode modem, which can process digital data and communicate with transceiver 302 such that the digital data is sent and received using transceiver 302. In some aspects, modem 340 can be multiband and be configured to support multiple frequency bands for a specific communications protocol. In some aspects, modem 340 can be multimode and be configured to support multiple operating networks and communications protocols. In some aspects, modem 340 can control one or more components of UE 104 (such as RF front end 388, transceiver 302) to enable transmission or reception of signals from the network based on a specified modem configuration. In some aspects, the modem configuration can be based on the mode of the modem and the frequency band in use. In another aspect, the modem configuration can be based on UE configuration information associated with UE 104 as provided by the network during cell selection or cell reselection.

In some aspects, communicating component 342 can optionally include a RA message component 352 for generating or communicating random access messages as part of a random access procedure, such as Msg1, Msg2, Msg3, or Msg4 in a four-step PRACH procedure, or a power comparing component 354 for comparing a signal power measurement to a threshold in determining whether to request resources for repetition of an uplink channel transmission for Msg3, as described herein.

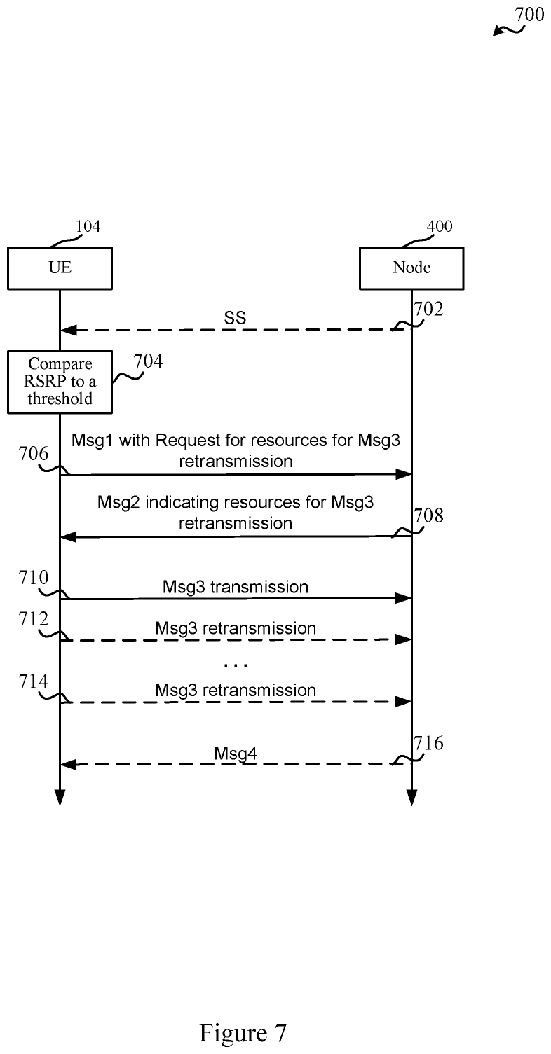

In some aspects, the processor(s) 312 may correspond to one or more of the processors described in connection with the UE in FIG. 7. Similarly, the memory 316 may correspond to the memory described in connection with the UE in FIG. 7.

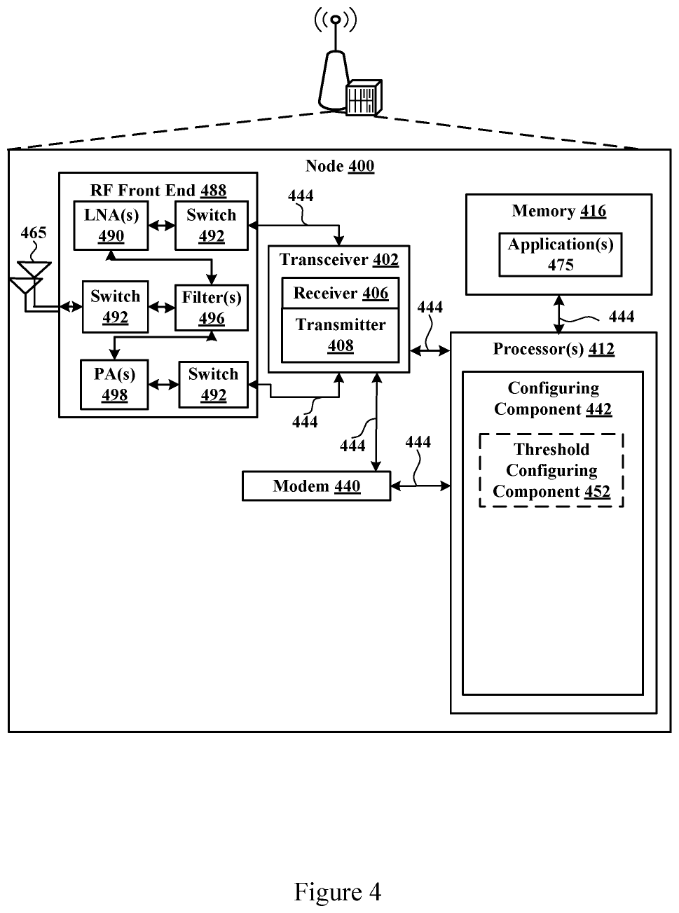

Referring to FIG. 4, one example of an implementation of a node 400, such as a base station 102 (such as a base station 102 or gNB 180, as described above), which may be a monolithic base station, one or more components of a disaggregated base station, etc., as described above. The node 400 may include a variety of components, some of which have already been described above, but including components such as one or more processors 412 and memory 416 and transceiver 402 in communication via one or more buses 444, which may operate in conjunction with modem 440 and configuring component 442 for configuring a device for requesting resources for repetition of an uplink channel transmission in a random access procedure, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for node (or base station) operations as opposed to UE operations.

In some aspects, configuring component 442 can optionally include a threshold configuring component 452 for configuring one or more parameters related to a threshold to use in comparing a signal power measurement in determining whether to request resources for repetition of an uplink channel transmission in a random access procedure, in accordance with aspects described herein.

In some aspects, the processor(s) 412 may correspond to one or more of the processors described in connection with the base station in FIG. 7. Similarly, the memory 416 may correspond to the memory described in connection with the base station in FIG. 7.

FIG. 5 illustrates an example of a flow chart 500 for requesting resources for repetition of an uplink channel transmission in a random access procedure. In an example, a UE 104 can perform the functions described in the flow chart 500 using one or more of the components described in FIGS. 1 and 3.

At block 502, a first indication of a first random access message (Msg1) for a PRACH procedure can be generated where the first random access message includes a request for repetitions of a third random access message (Msg3), where the request is based on a criterion that is associated with at least one of a maximum allowed transmit power of the UE or a PRACH transmit power of the UE. In some aspects, RA message component 352, such as in conjunction with processor(s) 312, memory 316, transceiver 302, communicating component 342, etc., can generate the first random access message (Msg1) for the PRACH procedure, where the first random access message includes a request for repetition of a third random access message (Msg3), where the request is based on a criterion that is associated with at least one of the maximum allowed transmit power of the UE, or the PRACH transmit power of the UE. In an example, the first random access message can be a PRACH preamble used to initiate the PRACH procedure with the node (such as the base station or portion thereof, for a disaggregated base station). The first random access message can include an indicator indicating whether resources for repetition of an uplink channel transmission for the third random access message is requested or not. In an example, RA message component 352 can include the request in the first random access message based on the criterion associated with at least one of the maximum allowed transmit power of the UE, or the PRACH transmit power of the UE. For example, whether to include the request, or the indicator of the request, in the first random access message can be based on a maximum allowed transmit power or PRACH transmit power of the UE 104, comparing the maximum allowed transmit power or PRACH transmit power to one or more thresholds, etc., as described further herein.

In one example, the maximum allowed transmit power or PRACH transmit power of the UE 104 can be based on a UE power class, as specified in 5G NR, where the maximum allowed transmit power can be limited for certain UE power classes. In another example, the maximum allowed transmit power or PRACH transmit power of the UE 104 can be limited or reduced based on a MPE event. In either case, for example, considering the transmit power of the UE 104 (such as the maximum allowed transmit power or PRACH transmit power) in requesting, or determining whether to request, resources for repetition of the uplink channel transmission in the third random access message can improve likelihood of successful transmission of the uplink channel transmission as compared to where the consideration is only based on SS-RSRP.

Optionally, at block 504, the request can be included associated with whether a signal power measurement of a received reference signal is at least a threshold signal power. In some aspects, RA message component 352, such as in conjunction with processor(s) 312, memory 316, transceiver 302, communicating component 342, etc., can include the request associated with, or otherwise based on, whether a signal power measurement of a received reference signal is at least a threshold signal power. For example, communicating component 342 can receive the reference signal, such as a SS or other SSB signal from the node and can measure a signal power measurement of the reference signal. Power comparing component 354 can compare the signal power measurement of the reference signal to a threshold signal power. For instance, RA message component 352 can generate the first random access message to include the request for repetition where the signal power measurement does not meet (is not greater than or equal to) the threshold signal power.

In examples described herein, the threshold signal power, or the comparison itself, can be adjusted by a correcting term that is based on the maximum allowed transmit power or PRACH transmit power of the UE 104. For example, the correcting term may be a difference between a first maximum allowed transmit power of a highest UE power class and the PRACH or transmit power of the UE 104 or of the UE power class of the UE 104, a difference between a first maximum allowed transmit power of the UE 104 (or of the UE power class of the UE 104) and the PRACH or transmit power of the UE 104, and/or the like. In an example, power comparing component 354, such as in conjunction with processor(s) 312, memory 316, transceiver 302, communicating component 342, etc., can adjust the threshold signal power by the correcting term, and can use the adjusted threshold signal power in comparing the transmit power of the UE 104 for determining whether to request resources for Msg3 repetition. For example, criteria for triggering request of Msg3 repetition may be based on a threshold on SS-RSRP (or other SSB-based measurements) combined with a correcting term that is dependent on the UE power class or its maximum transmit power (based on its power class or MPE condition, or both). In one example, the threshold may be configured by the node (such as the base station 102, or a portion thereof), and optionally at block 506, an indication of the threshold signal power can be obtained. In some aspects, power comparing component 354, such as in conjunction with processor(s) 312, memory 316, transceiver 302, communicating component 342, etc., can obtain the indication of the threshold signal power. In one example, power comparing component 354 can obtain the indication from the transceiver 302 that receives the indication from the node. For example, power comparing component 354 can receive the threshold signal power in system information (such as remaining minimum system information (RMSI)), as defined in the wireless communication technology (such as 5G NR) standard or specification and accordingly implemented in the UE 104, memory 316 of the UE 104, or a combination thereof.

In one example, the node (such as a base station 102 or portion thereof) may configure two thresholds Th for the SSB-based RSRP for the UE 104, and where the SSB-based RSRP does not surpass Th, this may trigger the request for repetition of Msg3 (or for resources for transmitting repetitions of the uplink channel transmission of Msg3). Depending on the UE power class, a correcting term may be added to Th (such as by the node before configuring the threshold or by the power comparing component 354 when comparing the signal power measurement to threshold). In an example, the correcting terms (corresponding to the UE power class or maximum transmit power) may be defined in the wireless communication technology (such as 5G NR) standard or specification and accordingly implemented in the UE 104, in memory 316 of the UE 104, or a combination thereof.

In another example, power comparing component 354 can receive the correcting terms from the node (such as in RMSI). Thus, optionally at block 508, an indication of an adjustment to the threshold signal power can be obtained. In some aspects, power comparing component 354, such as in conjunction with processor(s) 312, memory 316, transceiver 302, communicating component 342, etc., can obtain (such as from the node, which may include a base station 102 or a portion thereof) the indication of the adjustment to the threshold signal power. In one example, power comparing component 354 can obtain the indication from the transceiver 302 that receives the indication from the node (which may include a base station 102 or a portion thereof). The indication of the adjustment may be based on a power class of the UE 104 or may include a list of adjustments per multiple UE power classes, per maximum allowed transmit powers of UEs (or ranges of transmit powers), per PRACH transmit powers of UEs (or ranges of PRACH transmit power), or the like. In an example, the correcting terms may be, or may be computed as, (Pmax-Pmax(UE)), where Pmax is the maximum transmit power among all power classes in a defined set of UE power classes (such as for the wireless communication technology), and Pmax (UE) is the maximum transmit power of the UE 104 (or maximum transmit power, corresponding to its power class).

Optionally, at block 510, the request can be included associated with whether a signal power measurement of the UE is at least a threshold signal power. In some aspects, RA message component 352, such as in conjunction with processor(s) 312, memory 316, transceiver 302, communicating component 342, etc., can include the request associated with, or otherwise based on, whether a signal power measurement of the UE 104 is at least a threshold signal power. For example, communicating component 342 can determine the signal power measurement for the UE 104, which may be computed based on the maximum allowed transmit power or PRACH transmit power and an observed or determined path loss from the UE 104 to the node (such as the base station 102 or portion thereof). In an example, power comparing component 354 can compare the signal power measurement of the UE 104 to a threshold signal power. For instance, RA message component 352 can generate the first random access message to include the request for repetition where the signal power measurement does not meet (is not greater than or equal to) the threshold signal power.

In an example, the node can configure the threshold, and thus optionally at block 506, an indication of the threshold signal power can be received. In some aspects, power comparing component 354, such as in conjunction with processor(s) 312, memory 316, transceiver 302, communicating component 342, etc., can receive (such as from the node, which may include the base station 102 or a portion thereof) the indication of the threshold signal power, which can be a threshold signal power for the signal power measurement of the UE 104, as described above. In an example, the path loss used in computing the signal power measurement of the UE 104 can be the path loss used to determine a transmit power for the first random access message (Msg1). In one example, RA message component 352 can determine or measure the path loss based on a signal power measurement of a received signal (such as SSB) and a power used by the node to transmit the SSB, where the power may be indicated in the SSB or otherwise indicated to the UE 104 (such as in a configuration, in memory 316 as part of the wireless communication technology standard or specification, or the like).

Optionally, at block 512, the request can be included associated with whether the UE communicates in a paired or un-paired spectrum. In some aspects, RA message component 352, such as in conjunction with processor(s) 312, memory 316, transceiver 302, communicating component 342, etc., can include the request associated with, or otherwise based on, whether the UE 104 communicates in the paired or un-paired spectrum (such as whether the UE communicates using time division duplexing (TDD) or frequency division duplexing (FDD)). In an example, RA message component 352 can use criteria based on UL RSRP for determining whether to include the request in the first random access message where the UE communicates using FDD. In another example, RA message component 352 can use criteria based on SS-RSRP for determining whether to include the request in the first random access message where the UE communicates using TDD. In another example, RA message component 352 can use criteria based on SS-RSRP for FDD and can use criteria based on UL RSRP for TDD. For example, RA message component 352 may determine whether it is configured for FDD or TDD and can accordingly determine whether to include the request for resources for repetition in the first random access message based on SS-RSRP (and corresponding threshold comparison) or UL RSRP (and corresponding threshold comparison).

At block 514, the first random access message can be outputted for transmission to a node to initiate a PRACH procedure with the node. In some aspects, RA message component 352, such as in conjunction with processor(s) 312, memory 316, transceiver 302, communicating component 342, etc., can output the first random access message for transmission to the node (such as base station 102 or a portion thereof or another network node) to initiate the PRACH procedure with the node. For example, the first random access message may or may not include the request for repetition of Msg3 (or the request for resources for repetition of an uplink channel transmission of the Msg3) based on the considerations or determinations described above. In an example, RA message component 352 can output the first random access message for transmission by the transceiver 302 to the node.

At block 516, the first random access message can be transmitted to a node to initiate a PRACH procedure with the node. In some aspects, RA message component 352, such as in conjunction with processor(s) 312, memory 316, transceiver 302, communicating component 342, etc., can transmit the first random access message (e.g., as outputted in block 514) to the node (such as base station 102 or a portion thereof or another network node) to initiate the PRACH procedure with the node. As described, for example, the first random access message may or may not include the request for repetition of Msg3 (or the request for resources for repetition of an uplink channel transmission of the Msg3) based on the considerations or determinations described above.

Optionally, at block 518, a second random access message including a resource grant for transmitting at least one repetition of the third random access message can be obtained from the node and in response to the request. In some aspects, RA message component 352, such as in conjunction with processor(s) 312, memory 316, transceiver 302, communicating component 342, etc., can obtain, from the node (or another network node) and in response to the request, the second random access message including the resource grant for transmitting at least one repetition of the third random access message. In one example, RA message component 352 can obtain the second random access message from the transceiver 302 that receives the second random access message in signaling from the node. In this regard, for example, RA message component 352 can transmit the third random access message and one or more repetitions thereof (or of the uplink channel transmission of the third random access message) over resources indicated by the resource grant.

FIG. 6 illustrates an example of a flow chart 600 for configuring a device for requesting resources for repetition of an uplink channel transmission in a random access procedure. In an example, a node, such as a base station 102 (which may include a monolithic base station or one or more portions of a disaggregated base station), can perform the functions described in the flow chart 600 using one or more of the components described in FIGS. 1 and 4.

At block 602, a configuration indicating one or more parameters for selecting, based on a criterion that is associated with at least one of a maximum allowed transmit power of the UE or a PRACH transmit power of the UE, whether to request repetition of a third random access message in a PRACH procedure can be output for transmission to the UE. In some aspects, threshold configuring component 452, such as in conjunction with processor(s) 412, memory 416, transceiver 402, configuring component 442, etc., can output, for transmission to the UE, the configuration indicating one or more parameters for selecting, based on the criterion that is associated with or otherwise based on at least one of the maximum allowed transmit power of the UE or the PRACH transmit power of the UE, whether to request repetition (such as whether to request resources for repetition) of a third random access message in a PRACH procedure. For example, selecting the PRACH transmit power can include determining the PRACH transmit power based on at least one of the maximum allowed transmit power of the UE or the PRACH transmit power of the UE.

For example, the one or more parameters may indicate a threshold signal power determined for, or otherwise related to, the maximum allowed transmit power of the UE 104, a PRACH transmit power of the UE 104, etc. In an example, the one or more parameters may indicate the threshold signal power for each of multiple UE power classes, maximum allowed transmit powers (or range of powers) configurable for multiple UEs, PRACH transmit powers (or range of powers) configurable for multiple UEs, etc., such that the UE can select the threshold signal power associated to its transmit power. In addition, for example, the threshold signal power can relate to a SS-RSRP or UL RSRP, as described above. In another example, the one or more parameters may indicate a correcting term for a SS-RSRP that is based on the maximum allowed transmit power of the UE 104, a PRACH transmit power of the UE 104, etc. In an example, the one or more parameters may indicate the correcting term for each of multiple UE power classes, maximum allowed transmit powers (or range of powers) configurable for multiple UEs, PRACH transmit powers (or range of powers) configurable for multiple UEs, etc., such that the UE can select the correcting term applying to its transmit power.

Optionally at block 604, the configuration can be transmitted to the UE. In some aspects, threshold configuring component 452, such as in conjunction with processor(s) 412, memory 416, transceiver 402, configuring component 442, etc., can transmit the configuration to the UE. As described, threshold configuring component 452 can transmit the one or more parameters in RMSI or other signaling to the UE.

At block 606, a first random access message including a request for repetition of the third random access message can be obtained from the UE. In some aspects, configuring component 442, such as in conjunction with processor(s) 412, memory 416, transceiver 402, etc., can obtain, from the UE, the first random access message including the request for repetition of the third random access message. In one example, configuring component 442 can obtain the first random access message from the transceiver 402 that receives the first random access message in signaling from the UE. For example, configuring component 442 can obtain the first random access message (such as including a PRACH preamble) indicating the request, which the UE 104 can have determined to include based on the configuration, as described above. Moreover, for example, obtaining the first random access message from the UE can be associated with, or otherwise based on, the configuration.

Optionally at block 608, a second random access message can be output for transmission to the UE and associated with the request, including resources for repetition of the third random access message. In some aspects, configuring component 442, such as in conjunction with processor(s) 412, memory 416, transceiver 402, etc., can output, for transmission to the UE and associated with or otherwise based on the request, the second random access message (Msg2) including or otherwise indicating resources for repetition of the third random access message (or resources for repetition of the uplink channel transmission of the third random access message).

Optionally at block 610, the second random access message can be transmitted to the UE. In some aspects, configuring component 442, such as in conjunction with processor(s) 412, memory 416, transceiver 402, etc., can transmit, to the UE, the second random access message. Accordingly, for example, UE 104 can transmit, and base station 102 can receive, the one or more repetitions of Msg3, or the associated uplink channel transmission, over the scheduled resources.

FIG. 7 illustrates an example of a communication flow 700 between a UE 104 and a node 400 for requesting resources for Msg3 retransmission. In communication flow 700, the node 400 can optionally transmit a SS at 702, which can be received by the UE 104. The UE 104 can compare an RSRP to a threshold at 704. For example, this can be the RSRP of the SS received at 702, a UL RSRP computed based on a maximum allowed transmit power of the UE 104 and a path loss, or a combination thereof In one example, UE 104 can compute the path loss based on the SS received at 702. The UE 104 can transmit a Msg1 to the node 400, where the Msg1 includes a request for resources for Msg3 retransmission. For example, UE 104 can include the request for resources based on a criterion that is associated with at least one of a maximum allowed transmit power of the UE 104 or a PRACH transmit power of the UE 104. For example, UE 104 can include the request for Msg3 retransmission in the Msg1 where the RSRP does not achieve the threshold, as described above, and where the threshold can be associated with at least one of a maximum allowed transmit power of the UE 104 or a PRACH transmit power of the UE 104.

The node 400 can receive the Msg1 transmitted at 706 and can transmit a Msg2 at 708, where the Msg2 can indicate resources for Msg3 retransmission. For example, node 400 can include the resources for Msg3 retransmission based on the request received in the Msg1 at 706. For example, the Msg2 can indicate a number of resources for Msg3 retransmission (such as for a certain number of Msg3 retransmissions), and in one example, the node 400 can determine the number of resources based on one or more parameters indicated in the request in Msg1 (such as a RSRP, a difference between the RSRP and the threshold, etc.). Based on the resources indicated in Msg2, for example, the UE 104 can transmit Msg3 at 710, or one or more Msg3 retransmissions at 712 or 714, or some combination thereof. As described, transmitting the Msg3 repetitions can improve the likelihood of the node 400 receiving the Msg3 when RSRP does not achieve the threshold. Optionally, at 716, the node 400 can transmit Msg4 716 based on receiving one or more of the Msg3 transmission at 710 or Msg3 retransmission(s) at 712 or 714, or some combination thereof.

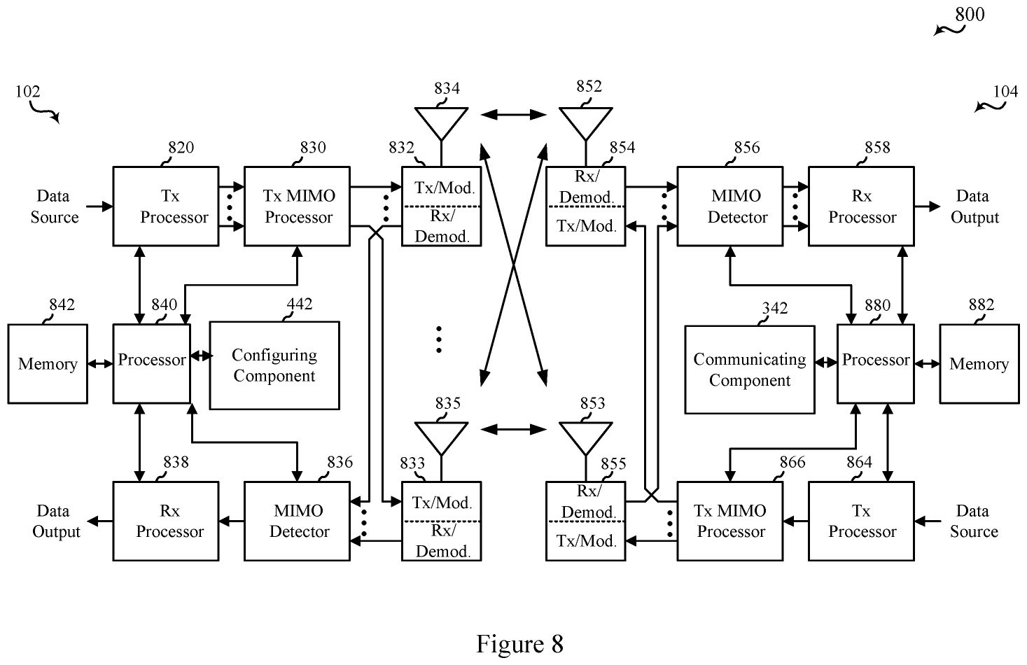

FIG. 8 illustrates a block diagram of an example communication system 800 including a base station 102, which can include a node 400, a monolithic base station, a disaggregated base station or portion thereof, etc., and a UE 104. The communication system 800 may illustrate aspects of the wireless communication access network 100 described with reference to FIG. 1. The base station 102 may be an example of aspects of the base station 102 described with reference to FIG. 1. In addition, the UE 104 can communicate with another UE over sidelink resources using similar functionality described herein with respect to UE 104 and base station 102 communications.

The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 820 may receive data from a data source. The transmit processor 820 may process the data. The transmit processor 820 also may generate control symbols or reference symbols. A transmit MIMO processor 830 may perform spatial processing (such as precoding) on data symbols, control symbols, or reference symbols, if applicable, and may provide output symbol streams to the transmit modulator/demodulators 832 and 833. Each modulator/demodulator 832 through 833 may process a respective output symbol stream (such as for OFDM, etc.) to obtain an output sample stream. Each modulator/demodulator 832 through 833 may further process (such as convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (such as filter, amplify, downconvert, and digitize) a respective received signal to obtain input samples. Each modulator/demodulator 854 through 855 may further process the input samples (such as for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (such as demodulate, deinterleave, and decode) the detected symbols, providing decoded data for the UE 104 to a data output, and provide decoded control information to a processor 880, or memory 882.

The processor 880 may in some cases execute stored instructions to instantiate a communicating component 342 (see such as FIGS. 1 and 3).

On the uplink (UL), at the UE 104, a transmit processor 864 may receive and process data from a data source. The transmit processor 864 also may generate reference symbols for a reference signal. The symbols from the transmit processor 864 may be precoded by a transmit MIMO processor 866 if applicable, further processed by the modulator/demodulators 854 and 855 (such as for SC-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor 838. The receive processor 838 may provide decoded data to a data output and to the processor 840 or memory 842.

The processor 840 may in some cases execute stored instructions to instantiate a configuring component 442 (see such as FIGS. 1 and 4).

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 800. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 800.

The following aspects are illustrative only and aspects thereof may be combined with aspects of other implementations or teaching described herein, without limitation.

Aspect 1 is a method for wireless communications at a UE including generating a first random access message for a PRACH procedure, where the first random access message includes a request for repetition of a third random access message, where the request is included in the first random access message and is associated with at least one of a maximum allowed transmit power of the UE, or a PRACH transmit power of the UE, and transmitting the first random access message to a node to initiate a random access procedure with the node.

In Aspect 2, the method of Aspect 1 includes where the request is included in the first random access message and is associated with the maximum allowed transmit power, and wherein the maximum allowed transmit power is associated with a power class of the UE.

In Aspect 3, the method of any of Aspects 1 or 2 includes where the request is included in the first random access message and is associated with the maximum allowed transmit power, and where the maximum allowed transmit power is based on a MPE event at the UE.

In Aspect 4, the method of any of Aspects 1 to 3 includes where the request is included in the first random access message and is associated with whether a signal power measurement of a received reference signal is at least a threshold signal power, where the threshold signal power is adjusted relative to at least one of the maximum allowed transmit power of the UE or the PRACH transmit power of the UE.

In Aspect 5, the method of Aspect 4 includes where the signal power measurement is one of a SS-RSRP measurement or other SSB-based measurement.

In Aspect 6, the method of any of Aspects 4 or 5 includes receiving, from the node, an indication of the threshold signal power.

In Aspect 7, the method of any of Aspects 4 to 6 includes receiving, from the node, an indication of an adjustment to the threshold signal power for one or more UE power classes, where the request is included in the first random access message and is associated with whether the signal power measurement of the received reference signal is at least the threshold signal power adjusted by the adjustment.

In Aspect 8, the method of any of Aspects 4 to 7 includes where the threshold signal power is adjusted by a difference between a first maximum allowed transmit power of a highest UE power class and the maximum allowed transmit power of the power class of the UE.

In Aspect 9, the method of any of Aspects 4 to 8 includes where the request is included in the first random access message and is associated with whether the UE is configured to communicate in a paired or un-paired spectrum.

In Aspect 10, the method of any of Aspects 1 to 3 includes where the request is included in the first random access message and is associated with whether a signal power measurement of the UE is at least a threshold signal power, where the signal power measurement of the UE is based on a difference between the maximum allowed transmit power and a path loss to the node.

In Aspect 11, the method of aspect 10 includes receiving, from the node, an indication of the threshold signal power.

In Aspect 12, the method of any of Aspects 10 or 11 includes where a transmit power for the first random access message is associated with the path loss.

In Aspect 13, the method of any of Aspects 10 to 12 includes where the request is included in the first random access message and is associated with whether the UE is configured to communicate in a paired or un-paired spectrum.

In Aspect 14, the method of any of Aspects 1 to 13 includes receiving, from the node and in response to the first random access message including the request, a second random access message including a resource grant for transmitting at least one repetition of the third random access message.

Aspect 15 is a method for wireless communications at a network node including transmitting, to a UE, a configuration indicating one or more parameters of a threshold signal power for selecting, associated with at least one of a maximum allowed transmit power of the UE, or a PRACH transmit power of the UE, whether to request repetition of a third random access message in a PRACH procedure, and receiving, from the UE and associated with the configuration, a first random access message including a request for repetition of the third random access message.

In Aspect 16, the method of Aspect 15 includes where the threshold signal power corresponds to a received signal power measurement of a signal received at the UE.

In Aspect 17, the method of Aspect 16 includes where the configuration indicates the one or more parameters including a threshold signal power adjusted for at least one of the maximum allowed transmit power of the UE, or the PRACH transmit power of the UE.

In Aspect 18, the method of Aspect 16 includes where the configuration indicates the one or more parameters including a correcting term for the threshold signal power for one or more of various power classes of the UE, maximum allowed transmit powers of the UE, or PRACH transmit powers of the UE.

In Aspect 19, the method of any of Aspects 15 to 18 includes where the threshold signal power corresponds to a signal power measurement of a signal for transmitting by the UE.

In Aspect 20, the method of any of Aspects 15 to 19 includes transmitting, associated with the request, a second random access message to the UE including resources for repetition of the third random access message.

Aspect 21 is a method for wireless communications at a UE including generating a first random access message for a PRACH procedure, where the first random access message includes a request for repetition of a third random access message, where the request is based on a criterion that is associated with at least one of a maximum allowed transmit power of the UE, or a PRACH transmit power of the UE, and outputting the first random access message for transmission to a node to initiate a random access procedure with the node.

In Aspect 22, the method of Aspect 21 includes where the criterion includes a threshold for the maximum allowed transmit power based on a UE power class.

In Aspect 23, the method of any of Aspects 21 or 22 includes where the criterion includes a threshold for the maximum allowed transmit power based on a MPE event.

In Aspect 24, the method of any of Aspects 21 to 23 includes where the criterion indicates whether a signal power measurement of a received reference signal is at least a threshold signal power, and adjusting the threshold signal power relative to at least one of the maximum allowed transmit power or the PRACH transmit power.

In Aspect 25, the method of Aspect 24 includes where the signal power measurement is one of a SS RSRP measurement or other SSB-based measurement.

In Aspect 26, the method of any of Aspects 24 or 25 includes obtaining, from the node, an indication of the threshold signal power.

In Aspect 27, the method of any of Aspects 24 to 26 includes obtaining, from the node, an indication of an adjustment to the threshold signal power for one or more UE power classes, where the criterion includes whether the signal power measurement of the received reference signal is at least the threshold signal power adjusted by the adjustment.

In Aspect 28, the method of any of Aspects 24 to 27 includes adjusting the threshold signal power by a difference between a first maximum allowed transmit power of a highest power class and the maximum allowed transmit power of the UE power class.

In Aspect 29, the method of any of Aspects 24 to 28 includes where the criterion includes whether the UE is configured to communicate in a paired or un-paired spectrum.

In Aspect 30, the method of Aspect 29 includes where the request is included in the first random access message and is associated with whether the UE is configured to communicate in a paired or un-paired spectrum.

In Aspect 31, the method of any of Aspects 21 to 23 includes where the criterion includes whether a signal power measurement is at least a threshold signal power, where the signal power measurement is associated with the maximum allowed transmit power and a path loss to the node.

In Aspect 32, the method of Aspect 31 includes obtaining, from the node, an indication of the threshold signal power.

In Aspect 33, the method of any of Aspects 31 or 32 includes where a transmit power for the first random access message is associated with the path loss.

In Aspect 34, the method of any of Aspects 21 to 33 includes obtaining, from the node and in response to the first random access message including the request, a second random access message including a resource grant for transmitting at least one repetition of the third random access message.

Aspect 35 is an apparatus for wireless communication including a memory configured to store instructions, and one or more processors configured to execute the instructions and cause the apparatus to perform the operations of one or more methods in Aspects 1 to 34.

Aspect 36 is a user equipment (UE) for wireless communication including a transceiver, a memory configured to store instructions, and one or more processors configured to execute the instructions and cause the UE to perform the operations of one or more methods in Aspects 1 to 34, wherein the transceiver is configured to transmit the first random access message to the node.

Aspect 37 is an apparatus for wireless communication including means for performing the operations of one or more methods in Aspects 1 to 34.

Aspect 38 is a computer-readable medium including instructions that, when executed by a processor or apparatus, cause the processor or apparatus to perform the operations of one or more methods in Aspects 1 to 34.

Aspect 39 is a method for wireless communications at a network node includes outputting, for transmission to a UE, a configuration indicating one or more parameters for selecting, based on a criterion that is associated with at least one of a maximum allowed transmit power of the UE, or a PRACH transmit power of the UE, whether to request repetition of a third random access message in a PRACH procedure, and obtaining, from the UE and associated with the configuration, a first random access message including a request for repetition of the third random access message.

In Aspect 40, the method of Aspect 39 includes where the one or more parameters correspond to a threshold for received signal power measurement of a signal received at the UE.

In Aspect 41, the method of Aspect 40 includes where the one or more parameters include a threshold signal power adjusted for at least one of the maximum allowed transmit power of the UE, or the PRACH transmit power of the UE.

In Aspect 42, the method of Aspect 40 includes where the one or more parameters include a correcting term for a threshold signal power for one or more of various power classes of the UE, maximum allowed transmit powers of the UE, or PRACH transmit powers of the UE.

In Aspect 43, the method of any of Aspects 39 to 42 includes where the threshold signal power corresponds to a signal power measurement of a signal for transmitting by the UE.

In Aspect 44, the method of any of Aspects 39 to 43 includes outputting a second random access message, associated with the request, for transmission to the UE including resources for repetition of the third random access message.

Aspect 45 is an apparatus for wireless communication including a memory configured to store instructions, and one or more processors configured to execute the instructions and cause the apparatus to perform the operations of one or more methods in Aspects 39 to 44.

Aspect 46 is a base station for wireless communication including a transceiver, a memory configured to store instructions, and one or more processors configured to execute the instructions and cause the base station to perform the operations of one or more methods in Aspects 39 to 44, wherein the transceiver is configured to transmit, to the UE, the configuration, and receive, from the UE, the first random access message.

Aspect 47 is an apparatus for wireless communication including means for performing the operations of one or more methods in Aspects 39 to 44.

Aspect 48 is a computer-readable medium including instructions that, when executed by a processor or apparatus, cause the processor or apparatus to perform the operations of one or more methods in Aspects 39 to 44.

As used herein, a phrase referring to “at least one of” a list of items refers to any combination of those items, including single members. As an example, “at least one of: a, b, or c” is intended to cover: a, b, c, a-b, a-c, b-c, a-a, a-a-b, a-a-bb-cc . . . and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
a memory configured to store instructions; and
one or more processors configured to execute the instructions and cause the apparatus to:
generate a first random access message for a physical random access channel (PRACH) procedure,
wherein the first random access message includes a request for repetition of a third random access message,
wherein the request is based on a criterion that is associated with at least one of a maximum allowed transmit power or a PRACH transmit power; and
output the first random access message for transmission to a node to initiate a random access procedure with the node.

2. The apparatus of claim 1, wherein the criterion includes a threshold for the maximum allowed transmit power based on a user equipment (UE) power class.

3. The apparatus of claim 1, wherein the criterion includes a threshold for the maximum allowed transmit power based on a maximum permissible exposure (MPE) event.

4. The apparatus of claim 1, wherein the criterion indicates whether a signal power measurement of a received reference signal is at least a threshold signal power, and wherein the one or more processors are configured to execute the instructions and cause the processor to adjust the threshold signal power relative to at least one of the maximum allowed transmit power or the PRACH transmit power.

5. The apparatus of claim 4, wherein the signal power measurement is one of a synchronization signal (SS) reference signal received power (RSRP) measurement or other SS block (SSB)-based measurement.

6. The apparatus of claim 4, wherein the one or more processors are configured to execute the instructions and cause the apparatus to obtain, from the node, an indication of the threshold signal power.

7. The apparatus of claim 4, wherein the one or more processors are configured to execute the instructions and cause the apparatus to obtain, from the node, an indication of an adjustment to the threshold signal power for one or more user equipment (UE) power classes, wherein the criterion includes whether the signal power measurement of the received reference signal is at least the threshold signal power adjusted by the adjustment.

8. The apparatus of claim 4, wherein the one or more processors are configured to execute the instructions and cause the apparatus to adjust the threshold signal power by a difference between a first maximum allowed transmit power of a highest power class and the maximum allowed transmit power of a UE power class.

9. The apparatus of claim 1, wherein the criterion includes whether the apparatus is configured to communicate in a paired or un-paired spectrum.

10. The apparatus of claim 9, wherein the request is associated with whether the apparatus is configured to communicate in the paired or un-paired spectrum.

11. The apparatus of claim 1, wherein the criterion indicates whether a signal power measurement is at least a threshold signal power, wherein the signal power measurement is associated with the maximum allowed transmit power and a path loss to the node.

12. The apparatus of claim 11, wherein the one or more processors are configured to execute the instructions and cause the apparatus to obtain, from the node, an indication of the threshold signal power.

13. The apparatus of claim 11, wherein a transmit power for the first random access message is associated with the path loss.

14. The apparatus of claim 1, wherein the one or more processors are configured to execute the instructions and cause the apparatus to obtain, from the node and in response to the first random access message including the request, a second random access message including a resource grant for transmitting at least one repetition of the third random access message.

15. The apparatus of claim 1, further comprising a transceiver that is configured to transmit the first random access message to the node, wherein the apparatus is configured as a user equipment (UE).

16. A method for wireless communications at a user equipment (UE), comprising:
generating a first random access message for a physical random access channel (PRACH) procedure,
wherein the first random access message includes a request for repetition of a third random access message,
wherein the request is based on a criterion that is associated with at least one of a maximum allowed transmit power or a PRACH transmit power; and
outputting the first random access message for transmission to a node to initiate a random access procedure with the node.

17. The method of claim 16, wherein the criterion includes a threshold for the maximum allowed transmit power based on a UE power class.

18. The method of claim 16, wherein the criterion includes a threshold for the maximum allowed transmit power based on a maximum permissible exposure (MPE) event.

19. The method of claim 16, wherein the criterion includes whether a signal power measurement of a received reference signal is at least a threshold signal power, and further comprising adjusting the threshold signal power relative to at least one of the maximum allowed transmit power or the PRACH transmit power.

20. The method of claim 19, wherein the signal power measurement is one of a synchronization signal (SS) reference signal received power (RSRP) measurement or other SS block (SSB)-based measurement.

21. The method of claim 19, further comprising:
obtaining, from the node, an indication of the threshold signal power.

22. The method of claim 16, wherein the criterion at least one of includes whether the UE is configured to communicate in a paired or un-paired spectrum, wherein the request is associated with whether the UE is configured to communicate in the paired or un-paired spectrum, or indicates whether a signal power measurement is at least a threshold signal power, wherein the signal power measurement is associated with the maximum allowed transmit power and a path loss to the node.

23. The method of claim 16, further comprising obtaining, from the node and based on the first random access message including the request, a second random access message including a resource grant for transmitting at least one repetition of the third random access message.

24. An apparatus for wireless communication, comprising:
a memory configured to store instructions; and
one or more processors configured to execute the instructions and cause the apparatus to:
output, for transmission to a user equipment (UE), a configuration indicating one or more parameters for selecting, based on a criterion that is associated with at least one of a maximum allowed transmit power of the UE, or a physical random access channel (PRACH) transmit power of the UE, whether to request repetition of a third random access message in a PRACH procedure; and
obtain, from the UE, a first random access message including a request for repetition of the third random access message.

25. The apparatus of claim 24, wherein the one or more parameters correspond to a threshold for a received signal power measurement of a signal received at the UE.

26. The apparatus of claim 25, wherein the one or more parameters include a threshold signal power adjusted for at least one of the maximum allowed transmit power of the UE or the PRACH transmit power of the UE.

27. The apparatus of claim 25, wherein the one or more parameters include a correcting term for a threshold signal power for one or more of various power classes of the UE, maximum allowed transmit powers of the UE, or PRACH transmit powers of the UE.

28. The apparatus of claim 24, wherein the threshold signal power corresponds to a signal power measurement of a signal for transmitting by the UE.

29. The apparatus of claim 24, further comprising outputting a second random access message, associated with the request, for transmission to the UE including resources for repetition of the third random access message.

30. The apparatus of claim 24, further comprising a transceiver that is configured to at least one of transmit, to the UE, the configuration, or receive, from the UE, the first random access message, wherein the apparatus is configured as a base station.
